(19) United States
(12) Patent Application Publication
(10) Pub. No.: US 2016/0147282 A1
(43) Pub. Date: May 26, 2016

(54) Terminal Device and Method for Controlling Terminal Device

(71) Applicant: KYOCERA Corporation, Kyoto-shi (JP)

(72) Inventor: Shinya OGAWA, Osaka (JP)

(73) Assignee: KYOCERA Corporation

(21) Appl. No.: 15/011,343

(22) Filed: Jan. 29, 2016

Related U.S. Application Data
(63) Continuation of application No. PCT/JP2014/069568, filed on Jul. 24, 2014.

(30) Foreign Application Priority Data
Jul. 29, 2013 (JP) 2013-156735

(51) Int. Cl. G06F 1/32; G06F 3/041

(52) U.S. Cl. CPC G06F 1/3262; G06F 3/0416; G06F 1/3215; G06F 1/3231; G06F 1/3287

(57) ABSTRACT

A terminal device including a touchpad and at least one processor is provided. The touchpad includes a reception module configured to, when the operating state is a normal mode, receive a touch on a first region in a detection region of the touchpad, and when the operating state is a power saving mode, only receive a touch on a second region which is a partial region of the first region. The at least one processor is configured to, when the operating state is the power saving mode, transfer the operating state from the power saving mode to the normal mode in response to receiving the touch on the second region by the touchpad when the operating state is the power saving mode.

### CROSS-REFERENCE TO RELATED APPLICATION

The present application is a continuation based on PCT Application No. PCT/JP2014/069568 filed on Jul. 24, 2014, which claims the benefit of Japanese Application No. 2013-156735, filed on Jul. 29, 2013. PCT Application No. PCT/JP2014/069568 is entitled “Terminal Apparatus and Method for Controlling Terminal Apparatus”, and Japanese Application No. 2013-156735 is entitled “Terminal Device and Method for Controlling Terminal Device”. The content of which are incorporated by reference herein in their entirety.

### FIELD

Embodiments of the present disclosure relate to a terminal device including a touchpad, and a method for controlling the terminal device.

### BACKGROUND

In recent years, terminal devices including a touchpad, such as a touch panel, are widely used. Some of such terminal devices have a function of operating in a power saving mode of stopping power supply to respective parts of the terminal device including the touchpad, in order to reduce power consumption.

### SUMMARY

A terminal device of an aspect of the present disclosure includes a touchpad and at least one processor, and has an operating state including a first state and a second state where power consumption is smaller than in the first state. When the operating state is the first state, the touchpad receives a touch on a first region in a detection region of the touchpad, and when the operating state is the second state, only receives a touch on a second region which is a partial region of the first region. When the operating state is the second state, the at least one processor transfers the operating state from the second state to the first state in response to receiving the touch on the second region by the touchpad when the operating state is the second state.

A control method of an aspect of the present disclosure is a control method for controlling a terminal device including a touchpad and at least one processor, and having an operating state including a first state and a second state where power consumption is smaller than in the first state. When the operating state is the first state, the touchpad receives a touch on a first region in a detection region of the touchpad. The method includes only receiving a touch on a second region which is a partial region of the first region when the operating state is the second state, and transferring the operating state from the second state to the first state in response to receiving the touch on the second region by the touchpad when the operating state is the second state.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a block diagram showing a functional configuration of a terminal device according to a first embodiment.

FIG. 2 illustrates the terminal device according to the first embodiment as seen from the front surface.

FIG. 3A illustrates information stored in a register of a touchpad of the terminal device according to the first embodiment, showing available region information.

FIG. 3B illustrates information stored in the register of the touchpad of the terminal device according to the first embodiment, showing touch position information.

FIG. 4 is a schematic view showing how to detect a touch on an available region of a touch module of the touchpad of the terminal device according to the first embodiment.

FIG. 5 illustrates an example of setting region information stored in a memory of the terminal device according to the first embodiment.

FIG. 6A illustrates an example of a screen displayed on a display of the terminal device according to the first embodiment, showing an example of a home screen.

FIG. 6B illustrates an example of a screen displayed on a display of the terminal device according to the first embodiment, showing an example of a display screen of a setting application.

FIG. 6C illustrates an example of a screen displayed on a display of the terminal device according to the first embodiment, showing another example of a display screen of the setting application.

FIG. 7 is a flowchart showing an operation performed when a controller of the terminal device according to the first embodiment executes the setting application.

FIG. 8 is a flowchart showing an operation of causing an operating state of the terminal device according to the first embodiment to transition from a normal mode to a power saving mode.

FIG. 9A is a schematic view of an operation of causing the operating state of the terminal device according to the first embodiment to transition from the power saving mode to the normal mode, showing a display region of a display and an available region of the touchpad in the power saving mode.

FIG. 9B is a schematic view of an operation of causing the operating state of the terminal device according to the first embodiment to transition from the power saving mode to the normal mode, showing a state where a finger touches a region other than the available region.

FIG. 9C is a schematic view of an operation of causing the operating state of the terminal device according to the first embodiment to transition from the power saving mode to the normal mode, showing a state where a finger touches the available region.

FIG. 9D is a schematic view of an operation of causing the operating state of the terminal device according to the first embodiment to transition from the power saving mode to the normal mode, showing a state where the operating state has transitioned from the power saving mode to the normal mode and a home screen is displayed on the display.

FIG. 10 is a flowchart of the operation of causing the operating state of the terminal device according to the first embodiment to transition from the power saving mode to the normal mode.

FIG. 11 is a block diagram showing a functional configuration of a terminal device according to a second embodiment.

FIG. 12 illustrates an example of setting region information stored in a memory of the terminal device according to the second embodiment.

FIG. 13 illustrates an example of touch event information stored in the memory of the terminal device according to the second embodiment.

FIG. 14 illustrates an example of gesture information stored in the memory of the terminal device according to the second embodiment.

FIG. 15 is a flowchart of an operation of the terminal device according to the second embodiment.

FIG. 16 is a block diagram showing a functional configuration of a terminal device according to a third embodiment.

FIG. 17 illustrates an appearance of the terminal device according to the third embodiment, showing at (a) the terminal device as seen from the front surface, and at (b) the terminal device as seen from the side surface.

FIG. 18 is a flowchart of an operation of the terminal device according to the third embodiment.

### DETAILED DESCRIPTION

### First Embodiment

A terminal device 1 of a first embodiment is a smartphone including a touch panel. The touch panel includes a display and a touchpad. The terminal device 1 can operate in either of two operating states: a normal mode; and a power saving mode. The normal mode is an operating state used when an operator manipulates terminal device 1, where the display displays a character, an image and the like. The power saving mode is an operating state used while an operator does not manipulate terminal device 1, such as, for example, while an operator carries terminal device 1 in his/her bag or while he/she is asleep, where power supply to the display is stopped to reduce power consumption.

In a terminal device, it is usual to perform an input with a hardware button in order to cause the operating state to transition from the power saving mode to the normal mode of supplying electric power to each part of the terminal device.

Depending on the arrangement place, the hardware button may impair usability of the terminal device by, for example, forcing a user of the terminal device to change one hand holding the terminal device to the other hand at the time of inputting.

There may be a demand for a terminal device capable of transitioning from the power saving mode to the normal mode while minimizing impairment of user's usability.

The touchpad of terminal device 1 has its detection region divided into two regions: an available region; and an unavailable region other than the available region, and only receives a touch on the available region. When the operating state of terminal device 1 is the normal mode, the available region of the touchpad may be the whole display region of the display. When the operating state of terminal device 1 is the power saving mode, the available region of the touchpad may be part of the display region of the display.

While operating in the normal mode, terminal device 1 can shift the operating state to the power saving mode when a touch on the available region has not been received for a certain period of time. While operating in the power saving mode, terminal device 1 can shift the operating state to the normal mode when a touch on the available region has been received.

Terminal device 1 of the first embodiment will be described below in detail with reference to the drawings.

### <Configuration of Terminal Device 1>

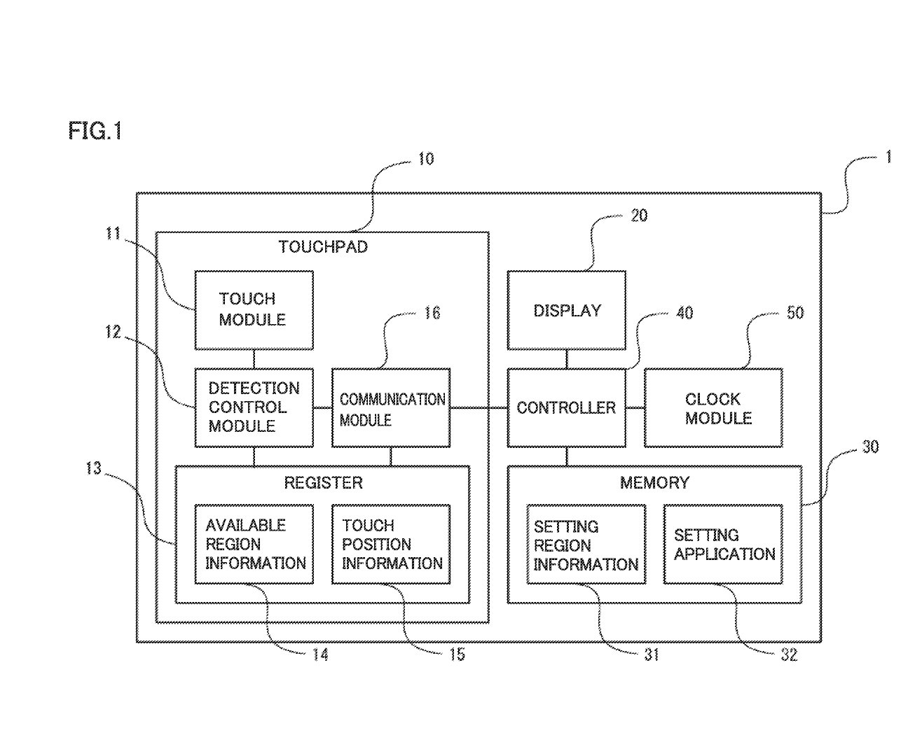

FIG. 1 is a block diagram showing a functional configuration of terminal device 1 according to the first embodiment. As shown in FIG. 1, terminal device 1 includes a touchpad 10, a display 20, a memory 30, a controller 40, and a clock module 50.

In the first embodiment, touchpad 10 is a capacitance type touchpad and includes a touch module 11, a detection control module 12, a register 13, and a communication module 16.

Touch module 11, which is a detection region of touchpad 10, is a portion touched by an operator with his/her finger, a dedicated stylus or the like, and may be disposed to cover a display region of display 20.

Detection control module 12 can detect a touch on the available region of touch module 11 and the position where the touch has been made. Upon detection of the touch on the available region of touch module 11, detection control module 12 can notify the fact to communication module 16. Detection control module 12 can generate information indicating the position where the touch has been made, and can cause register 13 to store the information as touch position information 15.

Register 13 is a storage element built in touchpad 10, and can store available region information 14 indicating the available region of touch module 11 and touch position information 15 indicating the position where a touch has been made.

When a touch on the available region of touch module 11 is notified from detection control module 12, communication module 16 can generate an interrupt signal for transmission to controller 40. Communication module 16 can receive a command from controller 40 to perform reading from register 13 and writing into register 13.

Display 20 may be a liquid crystal panel in the first embodiment, and can display a character, an image and the like under the control of controller 40.

Memory 30 can store data and a program necessary for operating terminal device 1. The data stored in memory 30 can include setting region information 31 indicating a set value of the available region of touch module 11. The program stored in memory 30 can include an application program (hereinafter referred to as a setting application 32) for an operator to set setting region information 31.

Memory 30 may be also utilized as a working area temporarily storing processing results of controller 40. In the first embodiment, memory 30 is configured to include a volatile storage element, such as DRAM, and a nonvolatile storage element, such as a flash memory.

Controller 40 includes an integrated circuit, such as CPU (Central Processing Unit), that can include a function of controlling touchpad 10, a function of controlling display 20, and a function of managing the operating state of terminal device 1, by executing the program stored in memory 30.

With the function of controlling touchpad 10, controller 40 can transmit a command to touchpad 10 to read information stored in register 13 or write information into register 13.

For example, controller 40 can transmit an available region update command for updating available region information 14 to touchpad 10, and can cause touchpad 10 to update available region information 14. The available region update command is transmitted to touchpad 10 when causing the operating state of terminal device 1 to transition.

Upon receipt of an interrupt signal from touchpad 10, controller 40 can transmit a touch position acquisition command for acquiring touch position information 15 to touchpad 10 to acquire touch position information 15 from touchpad 10. Controller 40 can determine at which position in display region 21 of display 20 a touch has been made based on acquired touch position information 15.

In the first embodiment, clock module 50 includes a crystal oscillator, and can supply a clock signal of a predetermined cycle to controller 40.

### <Appearance of Terminal Device 1>

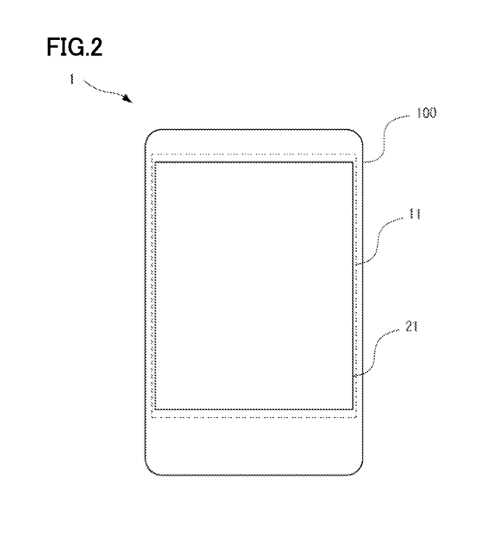

An appearance of terminal device 1 will be described. FIG. 2 illustrates terminal device 1 as seen from the front surface. As shown in FIG. 2, display region 21 of display 20 and touch module 11 of touchpad 10 covering display region 21 may be located on the front surface of a housing 100 of terminal device 1.

### <Details of Register 13>

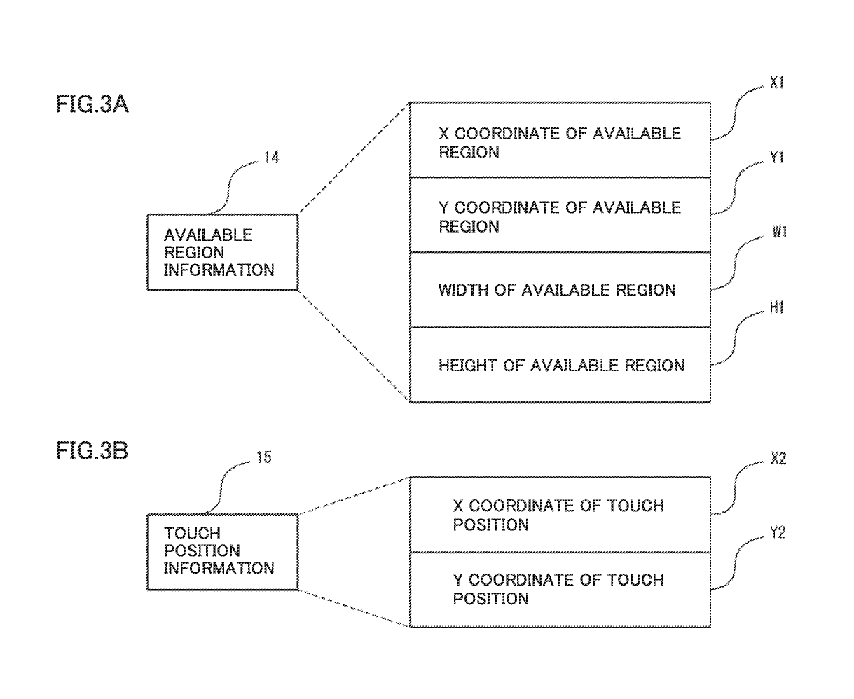

FIGS. 3A and 3B illustrate available region information 14 and touch position information 15 stored in register 13 of touchpad 10, respectively.

In the first embodiment, the available region may be rectangular and indicated by an X coordinate, a Y coordinate, a width, and a height in a coordinate system on display region 21 of display 20. Available region information 14 may include information indicating an X coordinate X1, a Y coordinate Y1, a width W1, and a height H1 in the coordinate system on display region 21, as shown in FIG. 3A.

Touch position information 15 may include information indicating an X coordinate X2 and a Y coordinate Y2 of a touch position in the coordinate system on display region 21, as shown in FIG. 3B.

### <Details of Touch Module 11 and Detection Control Module 12>

A method for detecting a touch on the available region of touch module 11 by touch module 11 and detection control module 12 of touchpad 10 will be described.

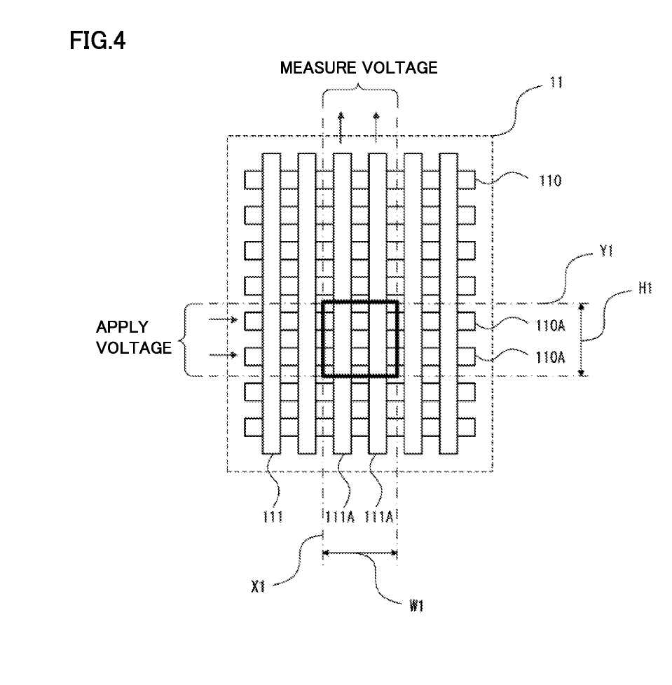

FIG. 4 is a schematic view of touch module 11 of the first embodiment as seen from the front surface. As shown in FIG. 4, touch module 11 is configured with a plurality of driving electrodes 110 extending in the X direction and a plurality of detection electrodes 111 extending in the Y direction perpendicular to the X direction arranged on a transparent substrate of glass or the like (not shown). Driving electrodes 110 and detection electrodes 111 are arranged to be insulated from each other with an insulating film (not shown) interposed therebetween.

When a pulse voltage is applied to driving electrode 110, a capacitance is produced at the intersection between driving electrode 110 and detection electrode 111. At this time, the capacitance varies as a finger approaches this intersection. By measuring the voltage waveform of detection electrode 111, approach of the finger to the intersection can be detected as a variation in the capacitance.

Detection control module 12 can read available region information 14 from register 13 to identify a driving electrode 110A included in the range from Y coordinate Y1 to height H1 of touch module 11. Detection control module 12 can identify a detection electrode 111A included in the range from X coordinate X1 to width W1 of touch module 11. Detection control module 12 can sequentially apply a pulse voltage only to driving electrode 110A having been identified, and can only measure a voltage waveform of detection electrode 111A having been identified.

By limiting driving electrode 110 to which a voltage is applied and detection electrode 111 whose voltage waveform is measured as described above, touch module 11 and detection control module 12 can only receive a touch on the available region.

Detection control module 12 uses a common detection cycle in the normal mode and the power saving mode of terminal device 1, and can apply a pulse voltage to each driving electrode 110A having been identified once in each detection cycle. Electric power consumed by touchpad 10 in the power saving mode is thus smaller than in the normal mode.

### <Details of Setting Region Information 31>

Setting region information 31 stored in register 13 will now be described. Setting region information 31 is composed of normal mode setting region information indicating a region which should be set as the available region of touch module 11 in the normal mode, and power saving mode setting region information indicating a region which should be set as the available region of touch module 11 in the power saving mode. Each of the normal mode setting region information and the power saving mode setting region information includes information indicating the X coordinate, the Y coordinate, the width, and the height in the coordinate system on display region 21 of display 20. In the first embodiment, the available region in the power saving mode may be a rectangular region whose diagonal line has a length of more than or equal to 0.5 inch and less than or equal to 1 inch.

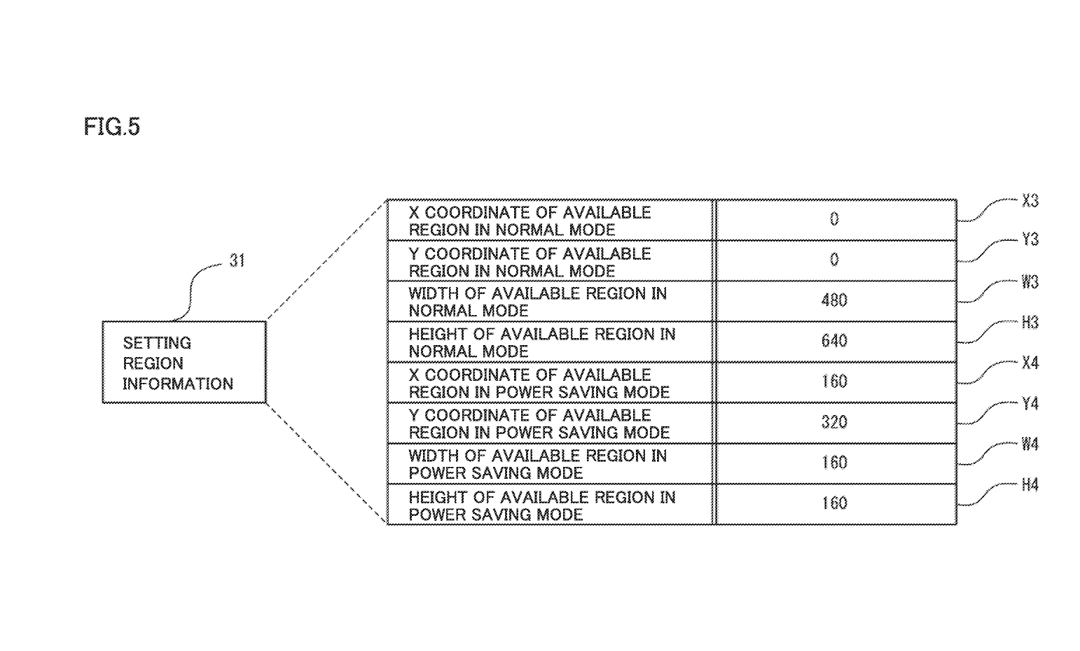

FIG. 5 illustrates an example of setting region information 31. As shown in FIG. 5, setting region information 31 has normal mode setting region information composed of an X coordinate X3, a Y coordinate Y3, a width W3, and a height H3 of the available region in the normal mode and power saving mode setting region information composed of an X coordinate X4, a Y coordinate Y4, a width W4, and a height H4 of the available region in the power saving mode.

When the operating state of terminal device 1 transitions from the normal mode to the power saving mode and when the operating state transitions from the power saving mode to the normal mode, this setting region information 31 is read by controller 40 for transmission to touchpad 10.

When causing the operating state of terminal device 1 to transition from the normal mode to the power saving mode, controller 40 can issue an available region update command for transmission to touchpad 10. At this time, controller 40 can read the power saving mode setting region information in setting region information 31 from memory 30 for transmission to touchpad 10 following the available region update command.

When causing the operating state of terminal device 1 to transition from the power saving mode to the normal mode, controller 40 can issue an available region update command for transmission to touchpad 10. At this time, controller 40 can read normal mode setting region information from memory 30 for transmission to touchpad 10 following the available region update command.

Upon receipt of the available region update command from controller 40, communication module 16 of touchpad 10 causes register 13 to store information on a region transmitted afterwards as available region information 14.

Through this process, the available region of touch module 11 becomes the whole display region 21 of display 20 of touch module 11 in the normal mode, and is limited to part of display region 21 of display 20 of touch module 11 in the power saving mode.

### <Process of Setting Available Region>

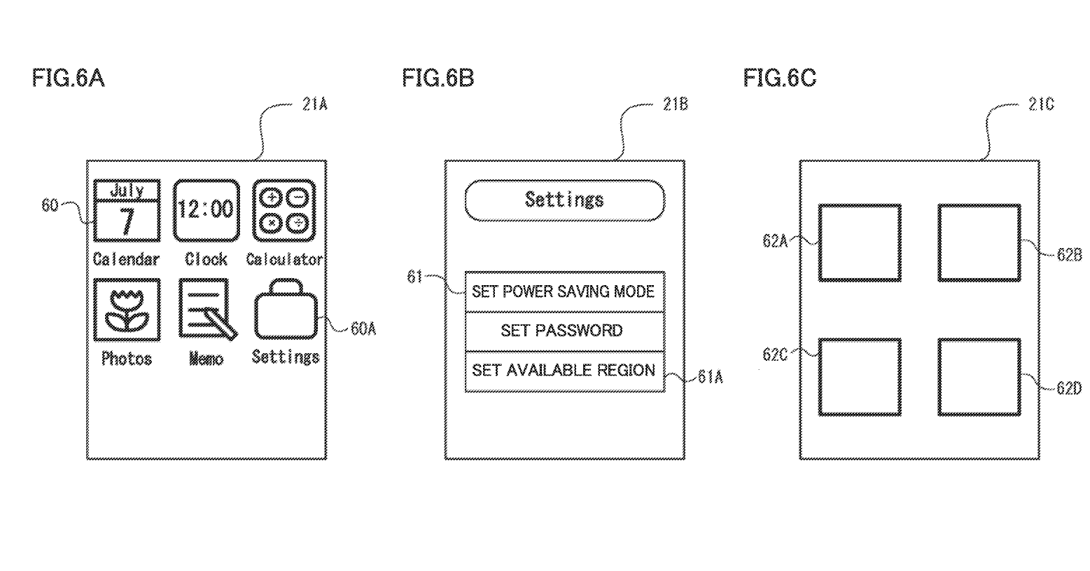

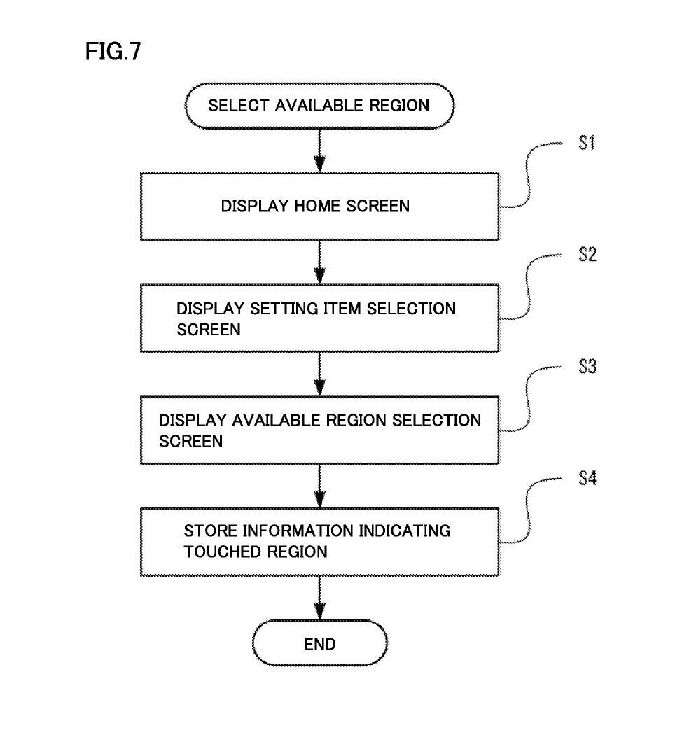

An operation in which controller 40 executes setting application 32 to set setting region information 31 of memory 30 will be described with reference to FIGS. 6 and 7. Herein, to set setting region information 31 is referred to as setting the available region.

FIGS. 6A to 6C each show an example of a screen displayed on display 20. FIG. 6A shows an example of a home screen of terminal device 1 of the first embodiment. FIGS. 6B and 6C each show an example of a display screen of setting application 32.

FIG. 7 is a flowchart showing an operation performed when controller 40 executes the setting application.

Controller 40 can cause display 20 to display a home screen 21A in the normal mode (FIG. 7: step S1). As shown in FIG. 6A, a plurality of icons 60 including an icon 60A for starting up setting application 32 are displayed on home screen 21A.

Upon detection of a touch on icon 60A for starting up setting application 32 with home screen 21A being displayed on display 20, controller 40 can cause display 20 to display a setting item selection screen 21B of setting application 32 shown in FIG. 6B (FIG. 7: step S2). A plurality of items 61 including an item 61A for setting the available region are displayed on setting item selection screen 21B.

Upon detection of a touch on item 61A for setting the available region with setting item selection screen 21B being displayed on display 20, controller 40 can cause display 20 to display an available region selection screen 21C of setting application 32 shown in FIG. 6C (FIG. 7: step S3). As shown in FIG. 6C, available region selection screen 21C displays a plurality of regions 62A to 62D.

Setting application 32 includes region information (X coordinate, Y coordinate, width, and height) indicating a region in the coordinate system on display region 21 as to each of a plurality of regions 62A to 62D.

Upon detection of a touch on one of plurality of regions 62A to 62D (e.g., region 62D) being displayed with available region selection screen 21C being displayed on display 20, controller 40 can cause memory 30 to store region information indicating region 62D from setting application 32 as power saving mode setting region information of setting region information 31 (FIG. 7: step S4).

Then, controller 40 can cause display 20 to display home screen 21A.

Through the operation described above, controller 40 can set the available region.

### <Process of Shifting to Power Saving Mode>

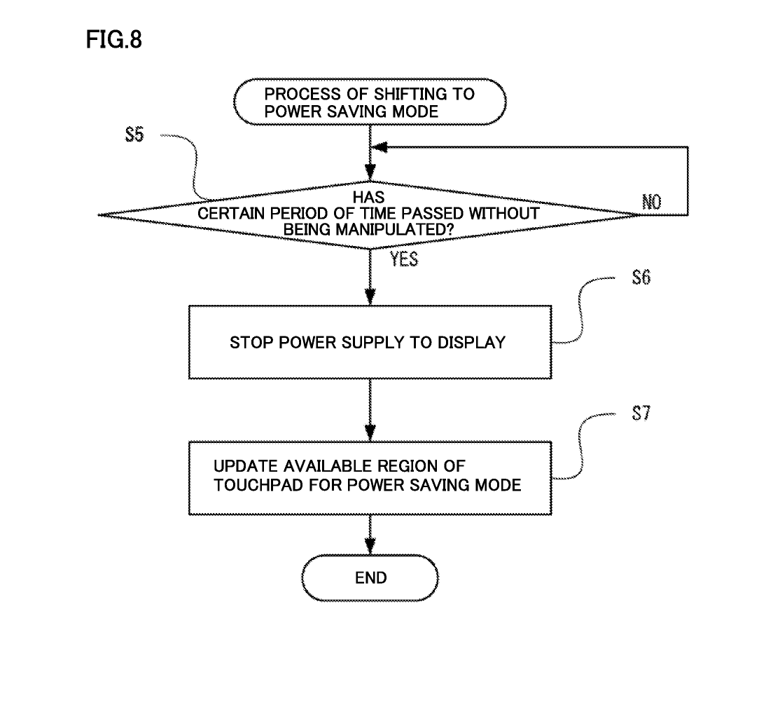

An operation in which controller 40 causes the operating state of terminal device 1 to transition from the normal mode to the power saving mode will be described with reference to FIG. 8.

FIG. 8 is a flowchart showing the operation in which controller 40 causes the operating state of terminal device 1 to transition from the normal mode to the power saving mode.

As shown in FIG. 8, when the operating state of terminal device 1 is the normal mode, controller 40 can determine whether or not a certain period of time (e.g., 60 seconds) has passed without terminal device 1 being manipulated (step S5). Specifically, controller 40 can measure a time period after the latest interrupt signal is received from touchpad 10, based on a clock signal from clock module 50.

When a certain period of time has passed after the latest interrupt signal is received from touchpad 10 (YES in step S5), controller 40 can cause the operating state of terminal device 1 to transition to the power saving mode. Controller 40 can stop power supply to display 20 (step S6).

Controller 40 can update the available region of touch module 11 of touchpad 10 to the available region in the power saving mode (step S7). Specifically, as described above, controller 40 can transmit an available region update command to touchpad 10 to cause available region information 14 stored in register 13 to be updated so as to indicate a region indicated by power saving mode setting region information stored in register 13.

Through the operation described above, controller 40 can cause the operating state of terminal device 1 to transition from the normal mode to the power saving mode.

### <Process of Shifting to Normal Mode>

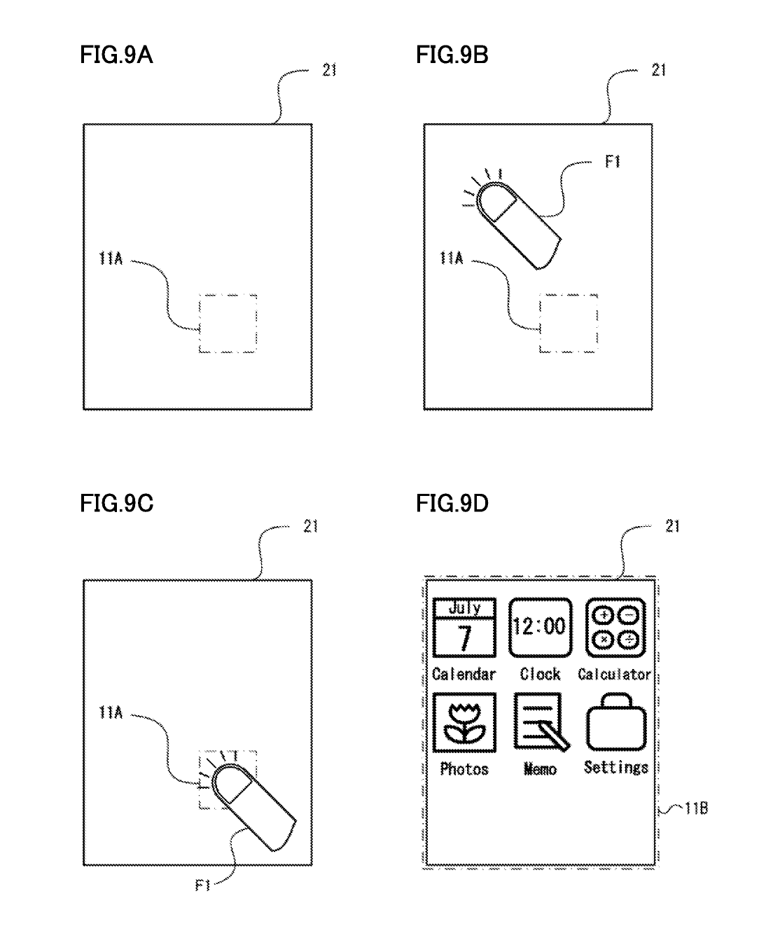

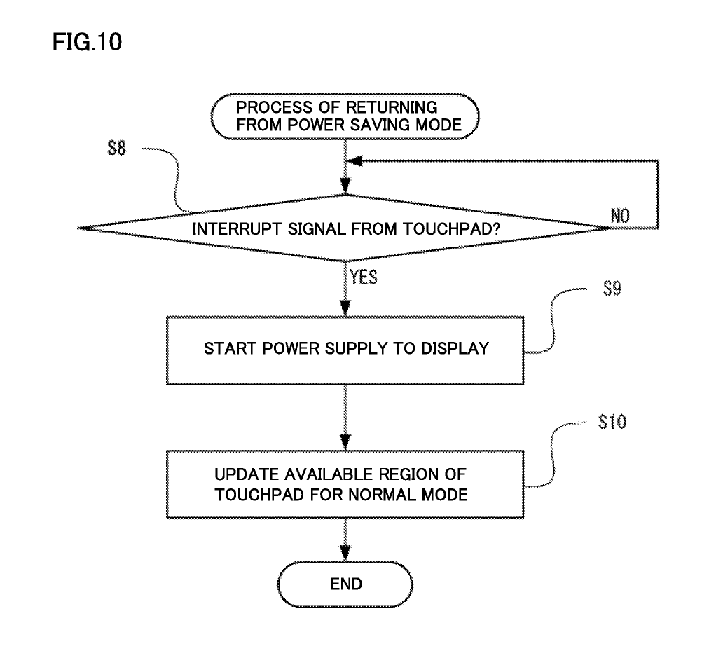

An operation in which controller 40 causes the operating state of terminal device 1 to transition from the power saving mode to the normal mode will be described with reference to FIGS. 9A to 9D and 10.

FIGS. 9A to 9D are schematic views of the operation of causing the operating state of terminal device 1 to transition from the power saving mode to the normal mode.

FIG. 9A shows display region 21 of display 20 and an available region 11A of touch module 11 of touchpad 10 in the power saving mode. Since power supply to display 20 has been stopped in the power saving mode as shown in FIG. 9A, nothing is displayed in display region 21. Available region 11A is a partial region of display region 21.

FIG. 9B shows a state where a user's finger F1 touches a region other than available region 11A, and FIG. 9C shows a state where user's finger F1 touches available region 11A.

FIG. 9D shows a state where the operating state of terminal device 1 has transitioned from the power saving mode to the normal mode, and the home screen is displayed in display region 21 of display 20. At this time, the available region of touch module 11 of touchpad 10 is a region 11B covering the whole area of display region 21 of display 20, as shown in FIG. 9D.

FIG. 10 is a flowchart of the operation in which controller 40 causes the operating state of terminal device 1 to transition from the power saving mode to the normal mode.

When the operating state of terminal device 1 is the power saving mode, controller 40 can determine whether or not an interrupt signal has been received from touchpad 10 (step S8).

Even if finger F1 touches a region other than available region 11A as shown in FIG. 9B, touchpad 10 does not detect the touch, and does not output an interrupt signal.

Touchpad 10 can only detect a touch with finger F1 on the area of available region 11A shown in FIG. 9C, and can output an interrupt signal to controller 40.

Upon receipt of an interrupt signal from touchpad 10 when the operating state of terminal device 1 is the power saving mode (YES in step S8), controller 40 can start power supply to display 20 of terminal device 1 (step S9). At this time, a home screen shown in FIG. 9D may be displayed on display 20.

Controller 40 can update the available region of touch module 11 of touchpad 10 to the available region in the normal mode (step S10). Specifically, controller 40 can transmit an available region update command to touchpad 10, and can update available region information 14 stored in register 13 to indicate a region indicated by the normal mode setting region information stored in memory 30. The available region of touch module 11 of touchpad 10 becomes region 11B covering the whole area of display region 21 of display 20, as shown in FIG. 9D.

As described above, controller 40 can cause the operating state of terminal device 1 to transition from the power saving mode to the normal mode while minimizing impairment of user's usability.

### <Effects of First Embodiment>

When operating in the power saving mode, terminal device 1 of the first embodiment divides the detection region of touchpad 10 into an available region where a touch therewith is to be received and an unavailable region where a touch therewith is not to be received, and only receives the touch on the available region.

With this configuration, since the available region of touchpad 10 is narrower in the power saving mode, the probability of occurrence of an erroneous input to touchpad 10 can be reduced. For example, the possibility of detecting contact between the terminal device and another article in a bag with the terminal device being carried in the bag can be reduced.

An operator can select the available region of touchpad 10 in the power saving mode from among a plurality of regions previously designated in the setting application. An operator can set the available region of touchpad 10 in the power saving mode at a convenient position for him/her to manipulate in the display region of display 20.

When a certain time period has passed in the normal mode without being manipulated, terminal device 1 of the first embodiment shifts to the power saving mode. With this configuration, power consumption while an operator does not manipulate terminal device 1 can be reduced.

Terminal device 1 of the first embodiment does not require an input with a hardware button for the shift from the normal mode to the power saving mode and for the shift from the power saving mode to the normal mode. For example, a terminal device having no hardware button can also be implemented.

### Second Embodiment

A terminal device 1100 of a second embodiment will be described. In the second embodiment, the power saving mode has functions of reducing power consumption of terminal device 1100 and locking the screen such that any person other than the owner of terminal device 1100 cannot use terminal device 1100.

Terminal device 1100 of the second embodiment further has a lock release input mode as an operating state, in addition to the normal mode and the power saving mode. The lock release input mode is an operating state to which transition is made when an interrupt signal is received from a touchpad in the case where the operating state of terminal device 1100 is the power saving mode. Upon detection of an input of a lock release gesture to an available region of the touchpad in the lock release input mode, terminal device 1100 releases the lock and transitions to the normal mode.

When transitioning from the power saving mode to the normal mode, terminal device 1100 requires a lock release gesture to be input to the available region of the touchpad via the lock release input mode. It is difficult for a person who does not know the lock release gesture to cause terminal device 1100 to shift from the power saving mode to the normal mode.

Terminal device 1100 of the second embodiment will be described below in detail with reference to the drawings. Features similar to those of terminal device 1 of the first embodiment have similar reference characters allotted, and description thereof will not be repeated.

### <Configuration of Terminal Device 1100>

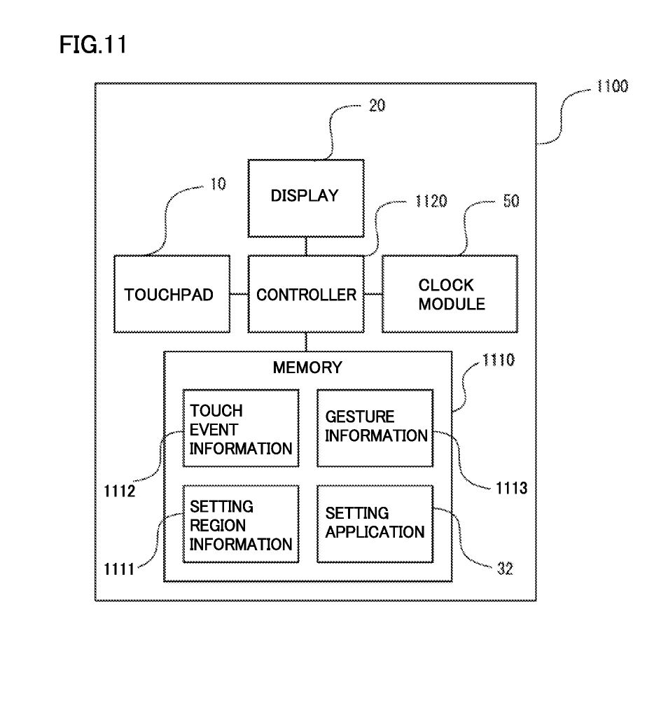

FIG. 11 is a block diagram showing a functional configuration of terminal device 1100 according to the second embodiment.

As compared with terminal device 1, terminal device 1100 includes a memory 1110 and a controller 1120 instead of memory 30 and controller 40.

Memory 1110 can hold setting region information 1111 instead of setting region information 31 held by memory 30. Memory 1110 can further hold touch event information 1112 and gesture information 1113 as compared with memory 30.

In addition to the functions of controller 40, controller 1120 can have a function of generating touch event information 1112 based on touch position information 15 acquired from touchpad 10 for storage in memory 1110. Controller 1120 can have a function of checking touch event information 1112 against gesture information 1113 to determine a touch manipulation performed on touch module 11.

### <Details of Setting Region Information 1111>

Setting region information 1111 held by memory 1110 will be described. Setting region information 1111 can include lock release input mode setting region information indicating a region which should be set as an available region of touch module 11 in the lock release input mode, in addition to the normal mode setting region information and power saving mode setting region information described in the first embodiment.

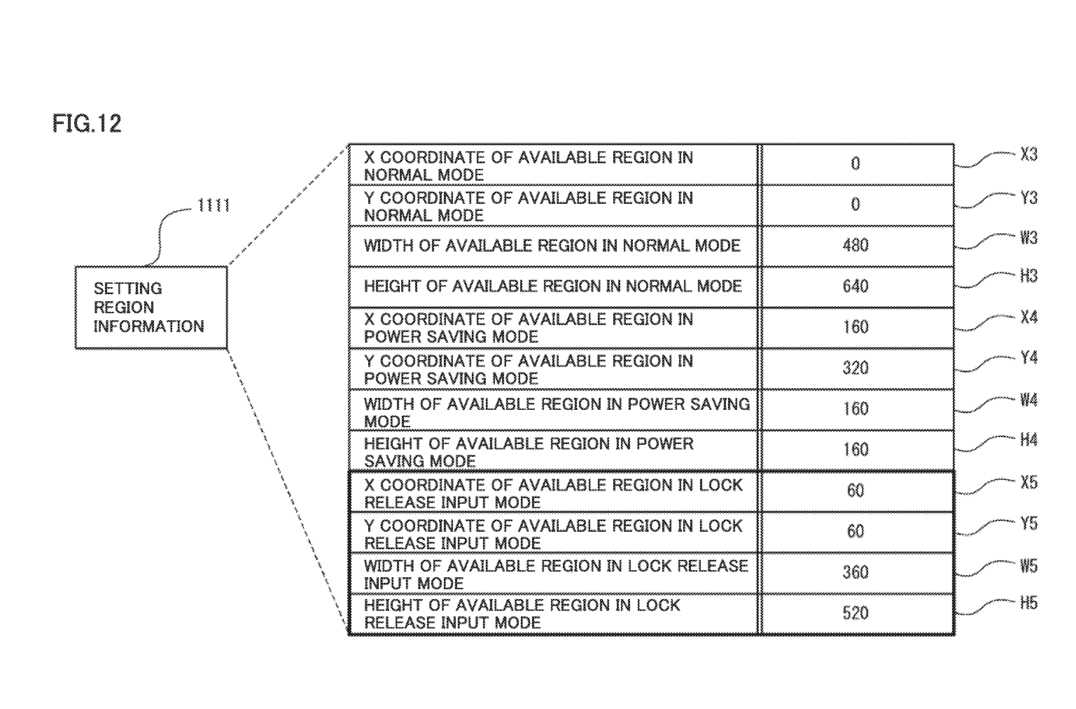

FIG. 12 illustrates an example of setting region information 1111. As indicated by the bold line in FIG. 12, setting region information 1111 can include the lock release input mode setting region information including an X coordinate X5, a Y coordinate Y5, a width W5, and a height H5 of an available region in the lock release input mode.

When the operating state of terminal device 1100 transitions to the lock release input mode, this lock release input mode setting region information is read by controller 1120 for transmission to touchpad 10 together with the available region update command.

### <Details of Touch Event Information 1112>

Touch event information 1112 held by memory 1110 will be described. Touch event information 1112 includes touch manipulations performed on touch module 11 of touchpad 10 as classified into a plurality of touch events so as to be easily handled by the application program.

In the second embodiment, there are three types of touch events: “Down” indicating the start of a touch manipulation; “Move” indicating the movement of a touch position; and “Up” indicating the termination of a touch manipulation.

Touchpad 10 can continue outputting interrupt signals to controller 1120 while a touch manipulation is being performed on touch module 11. Every time when an interrupt signal is received from touchpad 10, controller 1120 can acquire touch position information 15 from touchpad 10.

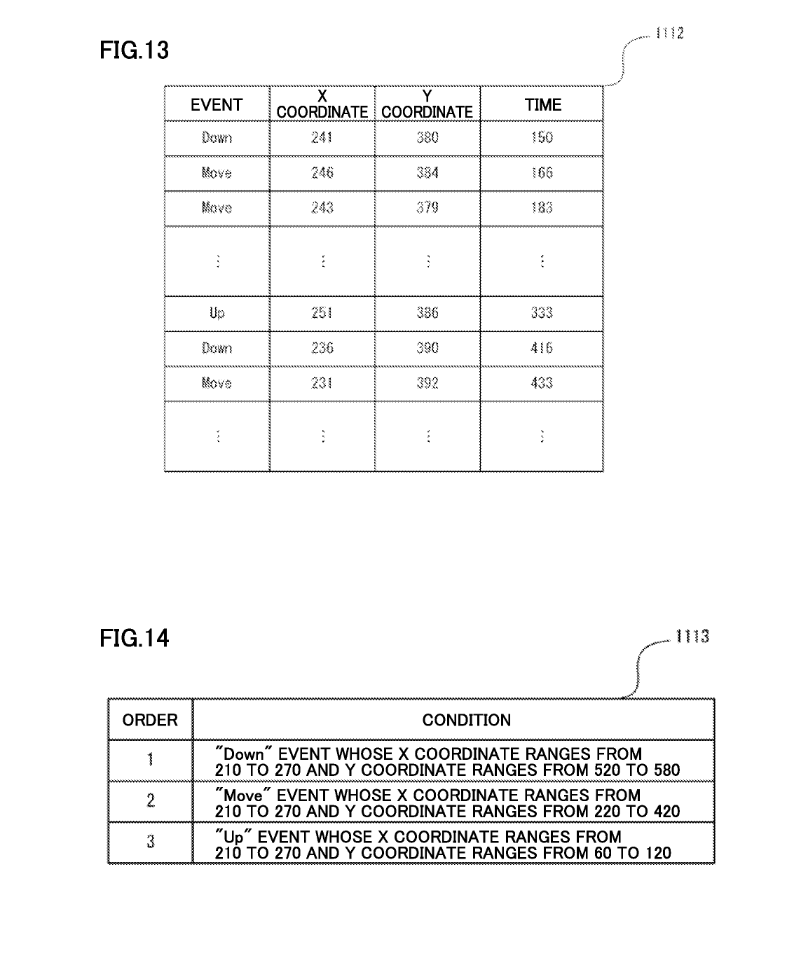

Controller 1120 can determine a touch event based on the received interrupt signal and acquired touch position information 15, and can associate the determined touch event with the touch position and touch time of that touch to generate touch event information 1112 shown in FIG. 13.

### <Details of Gesture Information 1113>

Gesture information 1113 stored in memory 1110 will be described.

Gesture information 1113 is information indicating a lock release gesture necessary for causing terminal device 1100 to shift from the lock release mode to the normal mode.

Controller 1120 can check touch event information 1112 against gesture information 1113 to determine whether or not the touch manipulation performed by an operator on touch module 11 of touchpad 10 is the lock release gesture.

In the second embodiment, the lock release gesture is sliding in the upward direction in display region 21 of display 20.

Specifically, controller 1120 can determine that the lock release gesture has been input when, in the available region in the lock release mode (a region whose X coordinate ranges from 60 to 420 and Y coordinate ranges from 60 to 580), a “Down” event whose X coordinate ranges from 210 to 270 and Y coordinate ranges from 520 to 580 occurs first, then a “Move” event whose X coordinate ranges from 210 to 270 and Y coordinate ranges from 220 to 420 occurs, and finally, an “Up” event whose X coordinate ranges from 210 to 270 and Y coordinate ranges from 60 to 120 occurs.

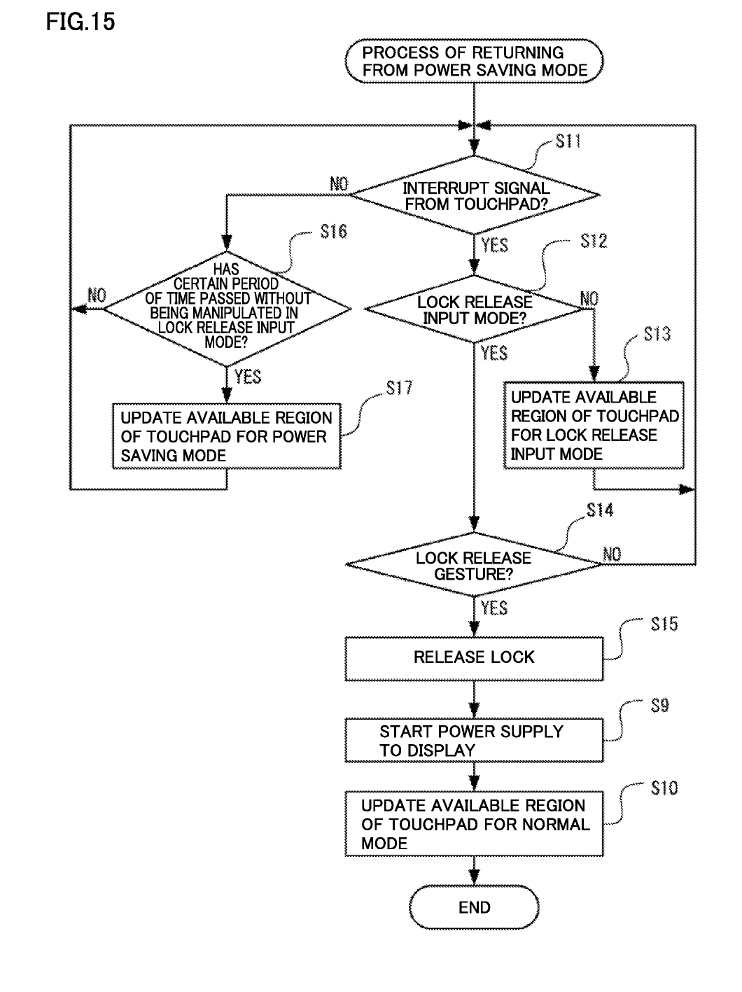

FIG. 14 illustrates an example of gesture information 1113. As shown in FIG. 14, gesture information 1113 includes conditions of a plurality of touch events and their order, for example.

### <Operation of Terminal Device 1100>

FIG. 15 is a flowchart of an operation of terminal device 1100.

As shown in FIG. 15, controller 1120 can determine whether or not an interrupt signal has been received from touchpad 10 when the operating state of terminal device 1100 is the power saving mode or the lock release input mode (step S11).

When an interrupt signal has been received from touchpad 10 in the case of the power saving mode or the lock release input mode (YES in step S11), controller 1120 can determine whether or not the operating state of terminal device 1100 is the lock release input mode (step S12).

When the operating state of terminal device 1100 is not the lock release input mode (NO in step S12), controller 1120 can cause the operating state of terminal device 1100 to transition to the lock release input mode. Controller 1120 can update the available region of touch module 11 of touchpad 10 to the available region in the lock release input mode (step S13), and can return the process to step S11.

When an interrupt signal has been received from touchpad 10 in the case where the operating state of terminal device 1100 is the lock release input mode (YES in step S12), controller 1120 can determine whether or not a touch manipulation on touch module 11 of touchpad 10 is the lock release gesture (step S14). Specifically, controller 1120 can acquire touch position information 15 from touchpad 10 to generate touch event information 1112, and can check touch event information 1112 against gesture information 1113.

When a determination is made that it is the lock release gesture as a result of checking (YES in step S14), controller 1120 releases the lock (step S15) and advances the process to steps S9 and S10. When a determination is made that it is not the lock release gesture (NO in step S14), controller 1120 can return the process to step S11.

In steps S9 and S10, controller 1120 can perform processing of causing the operating state of terminal device 1100 to shift to the normal mode similarly to controller 40 of the first embodiment. Controller 1120 can start power supply to display 20 to update the available region of touch module 11 of touchpad 10 to the available region in the normal mode.

When an interrupt signal has not been received from touchpad 10 in the case where the operating state of terminal device 1100 is the power saving mode or the lock release input mode (NO in step S11), controller 1120 can determine whether or not a certain period of time (e.g., 10 seconds) has passed without terminal device 1100 being manipulated when the operating state of terminal device 1100 is the lock release input mode (step S16). When the operating state of terminal device 1100 is the power saving mode, or when the operating state is the lock release input mode and a certain time period has not passed without terminal device 1100 being manipulated (NO in step S16), controller 1120 can return the process to step S11.

When the operating state of terminal device 1100 is the lock release input mode and a certain time period has passed without terminal device 1100 being manipulated (YES in step S16), controller 1120 can cause the operating state of terminal device 1100 to transition to the power saving mode. Controller 1120 can update the available region of touch module 11 of touchpad 10 to the available region in the power saving mode (step S17), and can return the process to step S11.

Terminal device 1100 operates as described above.

### <Effects of Second Embodiment>

Terminal device 1100 transitions from the power saving mode to the normal mode only when the lock release gesture is input. This makes it difficult for a person who does not know the lock release gesture to cause terminal device 1100 to shift from the power saving mode to the normal mode.

The available region of touch module 11 of touchpad 10 in the lock release input mode of inputting the lock release gesture is larger than the available region of touch module 11 of touchpad 10 in the power saving mode. Accordingly, a gesture of using a wider region can be set as the lock release gesture.

### Third Embodiment

A terminal device 1600 of a third embodiment further has a touchpad off mode of stopping power supply to touchpad 10 as an operating state. When a certain period of time continues without terminal device 1600 being manipulated in the power saving mode (hereinafter referred to as a display off mode), terminal device 1600 shifts to the touchpad off mode.

The touchpad off mode is a state where power supply to both touchpad 10 and display 20 is stopped, and the display off mode is a state where power supply to the display is stopped while power supply to the touchpad is continued.

Electric power consumed by terminal device 1600 when the owner of terminal device 1600 does not manipulate terminal device 1600 for a long time can be reduced.

Terminal device 1600 of the third embodiment will be described below in detail with reference to the drawings. Features similar to those of terminal device 1 of the first embodiment have similar reference characters allotted, and description thereof will not be repeated.

### <Configuration of Terminal Device 1600>

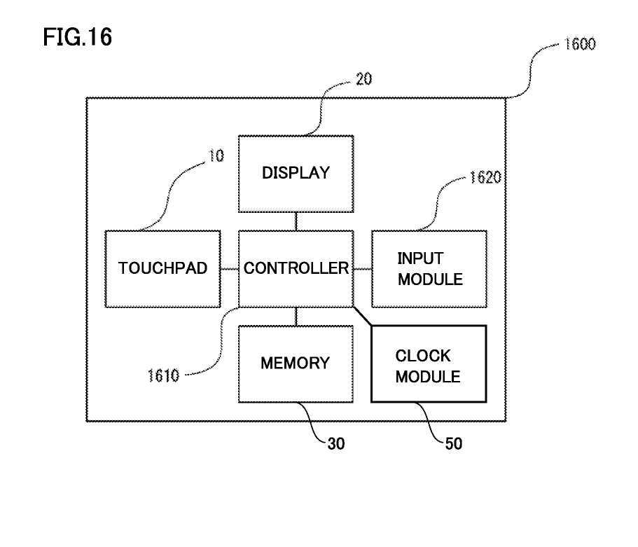

FIG. 16 is a block diagram showing the functional configuration of terminal device 1600 according to the third embodiment. As shown in FIG. 16, terminal device 1600 includes a controller 1610 instead of controller 40 of terminal device 1, and further includes an input module 1620.

In addition to the functions of controller 40, controller 1610 can have a function of causing the operating state of terminal device 1600 to shift from the display off mode to the touchpad off mode and a function of causing the operating state to shift from the touchpad off mode to the display off mode.

Input module 1620 includes a hardware button, and can transfer a manipulation performed by an operator to controller 1610.

### <Appearance of Terminal Device 1600>

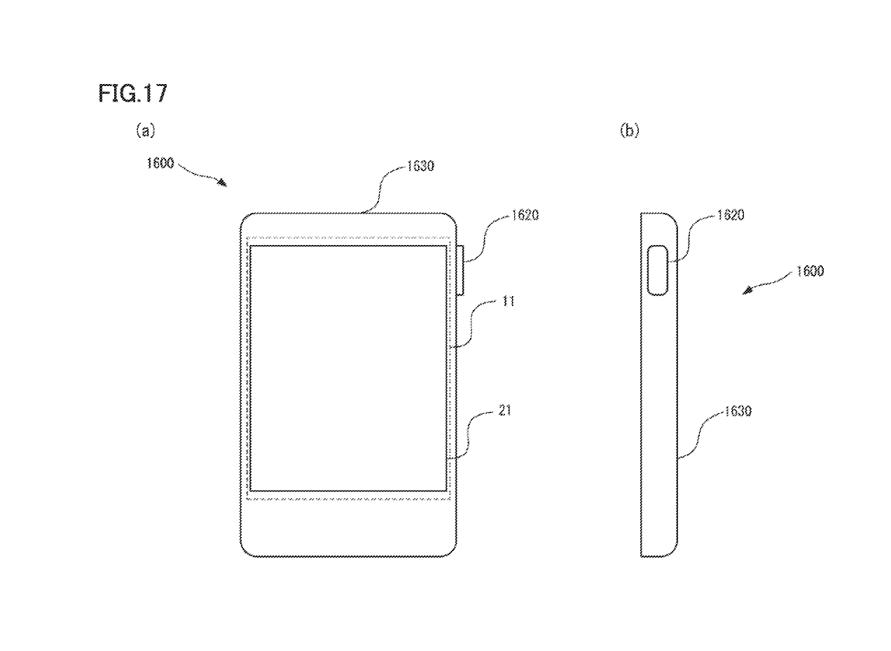

The appearance of terminal device 1600 will be described with reference to FIG. 17. FIG. 17 shows at (a) terminal device 1600 as seen from the front surface, and at (b) terminal device 1600 as seen from the side surface. As shown in FIG. 17, terminal device 1600 includes input module 1620 on the side surface of a housing 1630.

### <Operation of Terminal Device 1600>

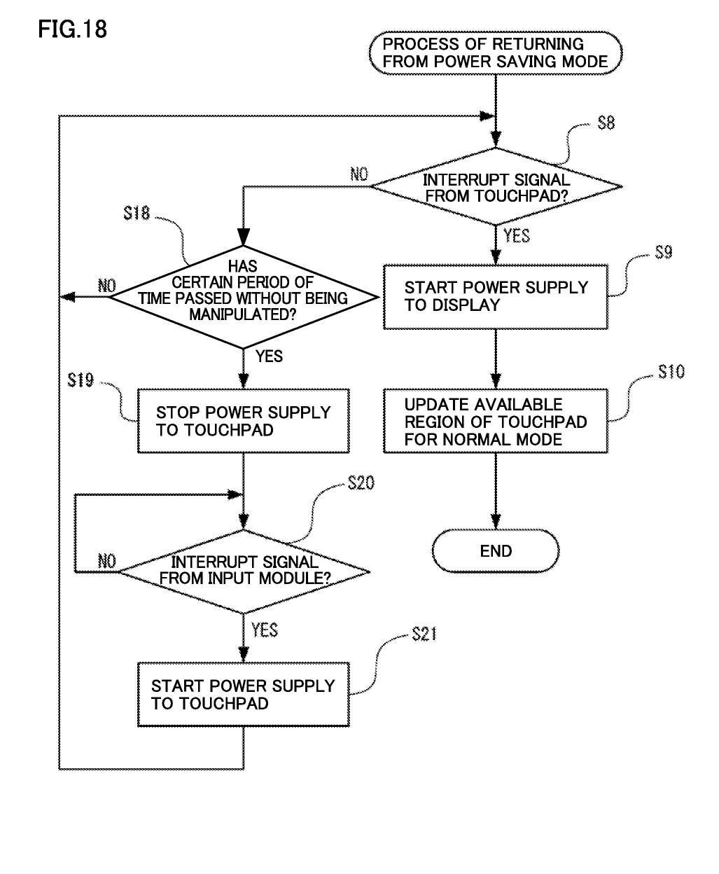

FIG. 18 is a flowchart of an operation of terminal device 1600.

As shown in FIG. 18, controller 1610 performs processing (steps S8, S9 and S10) of receiving an interrupt signal from touchpad 10 in the case of the display off mode to shift to the normal mode, similarly to the first embodiment.

When an interrupt signal has not been received from touchpad 10 in the display off mode (NO in step S8), controller 1610 determines whether or not a certain period of time (e.g., 300 seconds) has passed without terminal device 1600 being manipulated when the operating state is the display off mode (step S18). Specifically, controller 1610 can measure the time period after the latest interrupt signal is received from touchpad 10, based on a clock signal from clock module 50.

When a certain period of time has not passed after the latest interrupt signal is received from touchpad 10 (NO in step S18), controller 1610 can return the process to step S8.

When a certain period of time has passed after the latest interrupt signal is received from touchpad 10 (YES in step S18), controller 1610 can cause the operating state of terminal device 1600 to transition to the touchpad off mode. Controller 1610 can stop power supply to touchpad 10 (step S19).

Controller 1610 can wait until an input is received from input module 1620 after the shift to the touchpad off mode (step S20).

When an input has been received from input module 1620 (YES in step S20) in the touchpad off mode, controller 1610 can cause the operating state of terminal device 1600 to transition to the display off mode. Controller 1610 can start power supply to the touchpad (step S21), and can return the process to step S8 to continue the process.

Terminal device 1600 operates as described above.

### <Effects of Third Embodiment>

When a certain period of time continues without terminal device 1600 being manipulated in the display off mode, terminal device 1600 shifts to the touchpad off mode. Accordingly, electric power consumed by terminal device 1600 when the owner of terminal device 1600 does not manipulate terminal device 1600 for a long time can be reduced.

### (Supplement)

Although the terminal devices according to the present disclosure are described above based on the first to third embodiments, the illustrated terminal devices can also be modified as will be described below, and the present disclosure is not limited to the above-described embodiments.

(1) In above embodiments, the terminal devices are described as a smartphone by way of example, but are not limited thereto. For example, the terminal devices according to the present disclosure may be an electronic device, such as a mobile phone, a tablet computer, a mobile personal computer, a digital camera, a media player, a digital photo frame, a digital book reader, a navigator, or a game machine.

(2) In above embodiments, the power saving mode is described as the operating state where power supply to the display is stopped, but is not limited thereto. The power saving mode should just be an operating state of reducing electric power consumed by the terminal device, and may be, for example, an operating state of lowering the brightness of the display or an operating state of reducing the operating frequency of the controller.

(3) In above embodiments, the touchpad is described as a capacitance type touchpad, but is not limited thereto. The touchpad should just include a mechanism in which a touch on a region other than the available region is not detected by hardware, and the available region thereof can be changed under the control of the controller. The touchpad may be a matrix switch, or may be a resistance film type or electromagnetic induction type touchpad, for example.

(4) In above embodiments, the available region is described as being set by selecting a region from among plurality of regions 62A to 62D being displayed on available region selection screen 21C, but may be set by selecting two or more regions from among plurality of regions 62A to 62D being displayed. For example, in the case where two or more regions among plurality of regions 62A to 62D are continuously displayed, controller 40 can set a larger available region when a touch on the two or more continuous regions among plurality of regions 62A to 62D being displayed is detected. These two or more continuous regions form a rectangle as a whole, for example. In this case, for example, controller 40 can cause available region selection screen 21C to display a setting button, and when a touch on the setting button is detected after detection of a touch on plurality of regions 62A to 62D, can set plurality of regions 62A to 62D on which a touch has been detected as the available region in the power saving mode.

(5) In above embodiments, the available region of touchpad 10 in the power saving mode is described as being a rectangular region whose diagonal line has a length of more than or equal to 0.5 inch and less than or equal to 1 inch, but the terminal device of the present disclosure is not limited thereto. The available region of touchpad 10 in the power saving mode may have a diagonal line having a length of less than 0.5 inch or larger than 1 inch as long as it is a partial region of the available region in the normal mode. An operator may be able to freely set numeric values (X coordinate, Y coordinate, width, and height) of the available region of touchpad 10 in the power saving mode.

As the size of the available region in the power saving mode is smaller, the probability of detecting operator's unintentional a touch can be reduced. As the size of the available region in the power saving mode is smaller, it becomes more difficult for an operator to touch the available region.

Experimental results have revealed that an available region of touchpad 10 in the power saving mode set at a size of about the operators thumb is user-friendly.

(6) In above embodiments, the available region of touch module 11 of touchpad 10 in the lock release input mode is described as being larger than the available region of touch module 11 of touchpad 10 in the power saving mode, but may be narrower than the available region of touch module 11 of touchpad 10 in the power saving mode, or the available region may have the same area in the two modes. The available region of touch module 11 of touchpad 10 in the lock release input mode and the available region of touch module 11 of touchpad 10 in the power saving mode may overlap each other at least partially, or may be provided at completely different positions.

(7) In above embodiments, the lock release gesture is described as being sliding in the upward direction, but is not limited thereto. The lock release gesture should just allow a distinction to be made between an input made by an operator and an input made by another article having touched the available region of the touchpad without operator's intention.

The lock release gesture may be a double tap, a long tap or the like on the available region of the touchpad, for example.

The lock release gesture may be a complicated gesture in which a single tap, a double tap, a long tap, sliding in each direction, and the like are combined. In the case of a complicated gesture, it is possible to make it difficult for a person who does not know the gesture to cause the terminal device to shift from the power saving mode to the normal mode. The terminal device can be improved in security.

(8) In above embodiments, in the method for shifting from the normal mode to the power saving mode, a certain period of time is described as continuing without the terminal device being manipulated in the normal mode, but this is not a limitation. For example, in the case where the terminal device includes input module 1620 different from touchpad 10 as in the third embodiment, terminal device may shift to the power saving mode when an input to input module 1620 is detected in the normal mode.

(9) In the third embodiment, when an interrupt signal is received from input module 1620 in the touch sensor off mode, controller 1610 shall cause the operating state of terminal device 1600 to transition to the display off mode, but the operating state may be caused to transition from the touch sensor off mode to the normal mode.

(10) In the second embodiment, electric power shall not be supplied to the display in the lock release input mode, but may be supplied to the display in the lock release input mode to cause a lock release screen which prompts for lock release input to be displayed on the display.

For example, a password may be previously set in the terminal device, and a software keyboard which prompts for an input of a password may be displayed on the lock release screen, and when a password is input correctly by a touch manipulation on the software keyboard, transition may be made to the normal mode.

(11) A user may be able to previously set the process of returning from the power saving mode. For example, the process of returning from the power saving mode in the first embodiment may be applied to the terminal device of the second embodiment to allow a user to previously set by which of the returning process shown in FIG. 10 and the returning process shown in FIG. 18 the terminal device should return from the power saving mode.

(12) The modifications described above may be applied in combination to the terminal device described in each embodiment.

(13) A configuration of a terminal device according to an embodiment of the present disclosure, variations and effects thereof will be further described below.

(A) A terminal device according to an embodiment of the present disclosure includes a touchpad and at least one processor, and has an operating state including a first state and a second state where power consumption is smaller than in the first state. When the operating state is the first state, the touchpad receives a touch on a first region in a detection region of the touchpad, and when the operating state is the second state, the touchpad only receives a touch on a second region which is a partial region of the first region. When the operating state is the second state, the at least one processor transfers the operating state from the second state to the first state in response to receiving the touch on the second region by the touchpad when the operating state is the second state.

With this configuration, the terminal device transitions from the second state (power saving mode) to the first state (normal mode) with an input to the touchpad.

Since the second region is a partial region of the detection region of the touchpad, even if there is an operator's unintentional touch on the detection region of the terminal device, the touch itself is not detected unless it is a touch on the second region. As a result, the probability that the touchpad detects a user's unintentional touch can be reduced.

(B) The terminal device further includes a memory holding gesture information indicating a gesture on the detection region. The touchpad detects a position of the received touch. When the operating state is the second state, the at least one processor may determine whether or not to transfer the operating state from the second state to the first state by checking the position detected by the touchpad against the gesture information held by the memory, and may transfer the operating state from the second state to the first state depending on a determination result.

With this configuration, the terminal device transitions from the second state (power saving mode) to the first state (normal mode) only when a predetermined gesture is input. It is difficult for a person who does not know the predetermined gesture to cause the terminal device to shift from the power saving mode to the normal mode.

(C) In the terminal device, the operating state further includes a third state where power consumption is larger than in the second state. When the operating state is the third state, the touchpad only receives a touch on a third region in the detection region. The touchpad detects a position of the received touch. The memory holds gesture information indicating a gesture on the detection region. The at least one processor transfers the operating state from the second state to the first state via the third state. In response to receiving the touch on the second region by the touchpad when the operating state is the second state, the at least one processor may transfer the operating state from the second state to the third state, and when the operating state is the third state, may determine whether or not to transfer the operating state from the third state to the first state by checking the position detected by the touchpad against the gesture information held by the memory, and may transfer the operating state from the third state to the first state depending on a determination result.

With this configuration, it is possible to set a gesture using the third region different from the second region as a lock release gesture for shift to the first state (normal mode).

(D) In the terminal device, if the touch has not been received on the first region by the touchpad for a certain period of time when the operating state is the first state, the at least one processor may transfer the operating state from the first state to the second state.

With this configuration, electric power consumed by the terminal device while an operator does not manipulate the terminal device for a long time can be reduced.

(E) The terminal device further includes an input unit different from the touchpad. The operating state further includes a fourth state where power supply to the touchpad is stopped. If the touch has not been received on the second region by the touchpad for a certain period of time when the operating state is the second state, the at least one processor may transfer the operating state from the second state to the fourth state. If an input is received by the input unit when the operating state is the fourth state, the at least one processor may transfer the operating state from the fourth state to the second state.

With this configuration, electric power consumed by the terminal device while an operator does not manipulate the terminal device for a long time can be reduced.

(F) The terminal device further includes a display. The first state may be an operating state where electric power supplied to the display is larger than in the second state.

With this configuration, electric power consumed by the terminal device while operating in the power saving mode (second state) can be reduced.

With this configuration, while the terminal device is operating in the power saving mode, it is difficult to distinguish between an available region (second region) and an unavailable region (a region other than the second region) of the touchpad. It is possible to prevent a person who does not know the position of the available region (e.g., a person other than the owner of the terminal device) from shifting the terminal device from the power saving mode to the normal mode (first state). It is possible to prevent a person other than the owner of the terminal device from manipulating the terminal device.

(G) In the terminal device, any of partial regions of the first region may be able to be set as the second region.

This configuration allows an operator to set the available region (second region) of the touchpad in the second state at a convenient position for the operator to manipulate in the detection region of the touchpad.

(H) A control method for controlling a terminal device of an embodiment of the present disclosure is a control method for controlling a terminal device including a touchpad and at least one processor, and having an operating state including a first state and a second state where power consumption is smaller than in the first state. When the operating state is the first state, the touchpad receives a touch on a first region in a detection region of the touchpad. The control method includes only receiving a touch on a second region which is a partial region of the first region when the operating state is the second state, and transferring the operating state from the second to the first state in response to receiving the touch on the second region by the touchpad when the operating state is the second state.

Accordingly, the terminal device transitions from the second state (power saving mode) to the first state (normal mode) with an input to the touchpad.

Since the second region is a partial region of the detection region of the touchpad, even if there is an operator's unintentional touch on the detection region of the terminal device, the touch itself is not detected unless it is a touch on the second region. As a result, the probability that the touchpad detects a user's unintentional touch can be reduced.

(I) A terminal device according to an embodiment of the present disclosure includes a touchpad and at least one processor, and has an operating state including a first state and a second state where power consumption is smaller than in the first state. The touchpad receives a touch on a detection region. The detection region includes a first region and a second region which is a partial region of the first region. When the operating state is the second state, the at least one processor transfers the operating state from the second state to the first state in response to receiving the touch on the second region by the touchpad when the operating state is the second state.

The present disclosure is applicable to an electronic device, such as a smartphone, a mobile phone, a mobile personal computer, a digital camera, a media player, a digital photo frame, a digital book reader, a navigator, or a game machine.

Although the present disclosure has been described and illustrated in detail, it is clearly understood that the same is by way of illustration and example only and is not to be taken by way of limitation, the scope of the present disclosure being interpreted by the terms of the appended claims.

1. A terminal device comprising a touchpad and at least one processor, and having an operating state including a first state and a second state where power consumption is smaller than in the first state,
the touchpad being configured to, when the operating state is the first state, receive a touch on a first region in a detection region of the touchpad, and when the operating state is the second state, only receive a touch on a second region which is a partial region of the first region,
the at least one processor being configured to, when the operating state is the second state, transfer the operating state from the second state to the first state in response to receiving the touch on the second region by the touchpad when the operating state is the second state.

2. The terminal device according to claim 1, further comprising a memory configured to hold gesture information indicating a gesture on the detection region, wherein
the touchpad is configured to detect a position of the received touch, and
the at least one processor is configured to, when the operating state is the second state, determine whether or not to transfer the operating state from the second state to the first state by checking the position detected by the touchpad against the gesture information held by the memory, and transfer the operating state from the second state to the first state depending on a determination result.

3. The terminal device according to claim 1, wherein
the operating state further includes a third state where power consumption is larger than in the second state,
the touchpad is configured to, when the operating state is the third state, only receive a touch on a third region in the detection region,
the touchpad is further configured to detect a position of the received touch,
the memory holds gesture information indicating a gesture on the detection region, wherein
the at least one processor is configured to
transfer the operating state from the second state to the first state via the third state,
in response to receiving the touch on the second region by the touchpad when the operating state is the second state, transfer the operating state from the second state to the third state, and
when the operating state is the third state, determine whether or not to transfer the operating state from the third state to the first state by checking the position detected by the touchpad against the gesture information held by the memory, and transfer the operating state from the third state to the first state depending on a determination result.

4. The terminal device according to claim 1, wherein the at least one processor is configured to, if the touch has not been received on the first region by the touchpad for a certain period of time when the operating state is the first state, transfer the operating state from the first state to the second state.

5. The terminal device according to claim 1, further comprising an input unit different from the touchpad, wherein
the operating state further includes a fourth state where power supply to the touchpad is stopped, and
the at least one processor is configured to,
if the touch has not been received on the second region by the touchpad for a certain period of time when the operating state is the second state, transfer the operating state from the second state to the fourth state, and
if an input has been received by the input unit when the operating state is the fourth state, transfer the operating state from the fourth state to the second state.

6. The terminal device according to claim 1, further comprising a display, wherein electric power supplied to the display is larger in the first state than in the second state.

7. The terminal device according to claim 1, wherein any of partial regions of the first region can be set as the second region.

8. A control method for controlling a terminal device including a touchpad and at least one processor, and having an operating state including a first state and a second state where power consumption is smaller than in the first state,
the touchpad being configured to, when the operating state is the first state, receive a touch on a first region in a detection region of the touchpad,
the method comprising:
only receiving a touch on a second region which is a partial region of the first region when the operating state is the second state; and
transferring the operating state from the second state to the first state in response to receiving the touch on the second region by the touchpad when the operating state is the second state.

9. A terminal device comprising a touchpad and at least one processor, and having an operating state including a first state and a second state where power consumption is smaller than in the first state,
the touchpad being configured to receive a touch on a detection region, the detection region including a first region and a second region which is a partial region of the first region,
the at least one processor being configured to, when the operating state is the second state, transfer the operating state from the second state to the first state in response to receiving the touch on the second region by the touchpad when the operating state is the second state.
